(19) United States
(12) Patent Application Publication
(10) Pub. No.: US 2020/0389250 A1
(43) Pub. Date: Dec. 10, 2020

(54) MODULATION PROFILE ADAPTATION FOR MOCA

(71) Applicant: Intel Corporation, Santa Clara, CA (US)

(72) Inventors: Nathan Goichberg, Ashdod (IL); Shanl Shulman, Ramat Gan (IL)

(21) Appl. No.: 16/464,001

(22) PCT Filed: Dec. 28, 2016
(86) PCT No.: PCT/US2016/068809

§ 371 Date: May 24, 2019

(51) Int. Cl. H04L 1/00; H04L 12/28

(52) U.S. Cl. CPC H04L 1/0015; H04L 12/2801; H04L 1/0025; H04L 1/0009; H04L 1/0003

(57) ABSTRACT

This disclosure relates to a MoCA node comprising monitoring sub-system to monitor total power of all signals seen at an input of a transceiver of the MoCA node to obtain an total power value; and a processor to detect an increase in a current monitored total power value relative to a previous monitored total power value. The processor is configured to determine an updated modulation profile indicating a bitloading for subcarriers to be used by a transmitting MoCA node for transmissions on said subcarriers to the MoCA node, said determination being based on the detected increase in the current monitored total power value. The transceiver is configured to transmit said updated modulation profile to the transmitting MoCA node.

### TECHNICAL FIELD

This disclosure generally relates to the adaption of a modulation profile used in a Multimedia over Coax Alliance (MoCA)-based network. More specifically, this disclosure suggests a mechanism to allow a MoCA node to update the modulation profile of a transmitting MoCA node. This adaption may occur outside periodic link maintenance operations (LMO) implemented in MoCA-based technology.

### BACKGROUND

MoCA is an industry standard alliance (see http://www.mocalliance.org) developing technology for the connected home. MoCA technology can run over the existing in-home and in-building coaxial cabling, and aims at enabling whole-home distribution of media content (e.g. high definition video). Accordingly, example applications that can be realized with MoCA technology are multi-room digital video recorder (DVR), High-Definition Television (HDTV) and Ultra-High Definition (UHD) video distribution, gaming and HD/UHD and live streaming and overall improvement of Internet access throughout the home. MoCA technology works with any network access technology including fiber (e.g. Gigabit-capable Passive Optical Networks (GPONs) according to—for example—the ITU-T G.984 standard, or Ethernet Passive Optical Networks (EPONs) according to—for example—the IEEE standard 802.3ah), Data Over Cable Service Interface Specification (DOCSIS), EuroDOCSIS, Ethernet and any other means including wireless used to provide broadband to the home.

MoCA has published three different versions of the MoCA specification, which are commonly referred to as the MoCA 1.1 standard, the MoCA 2.0 standard, and MoCA 2.5 standard. The MoCA MAC/PITY SPECIFICATION v2.0 (MoCA-M/P-SPEC-V2.0-2013112) and MoCA, MAC/PHY SPECIFICATION v2.5 (MoCA-M/P-SPEC-V2.5-20160412) re available at http://wvww.mocalliance.org and are both incorporated herein by reference.

### BRIEF DESCRIPTION OF THE DRAWINGS

The various examples of this disclosure will be readily understood by the following detailed description in conjunction with the accompanying drawings. To facilitate this description, like reference numerals designate like elements. Embodiments are illustrated by way of example and not by way of limitation in the figures of the accompanying drawings.

FIG. 1 shows a MoCA node 100 in accordance with this disclosure;

FIG. 2 shows a flow chart of an example process performed by MoCA node 100 in accordance with a second aspect of this disclosure;

FIG. 3 shows exemplary implementation of a wideband MoCA receiver structure 300 for realizing the receiving circuitry 111 of the MoCA node 100 in accordance with this disclosure;

FIG. 4 shows exemplary implementation of a narrow-band MoCA receiver structure 400 for realizing the receiving circuitry 111 of the MoCA node 100 in accordance with this disclosure;

FIG. 5 shows another flow chart of an example process performed by MoCA node 100 in accordance with the second aspect of this disclosure;

FIG. 6 shows another flow chart of an example process performed by MoCA node 100 in accordance with a first aspect of this disclosure;

FIG. 7 shows another flow chart of an example process performed by MoCA node 100 in accordance with this disclosure for combining the first and second aspects of this disclosure;

FIG. 8 shows an exemplary MoCA network and illustrates reference points in the receiver chain of a MoCA node 800; and

FIG. 9 shows an example of signals received at MoCA node 800 from the MoCA network at different reference points highlighted in FIG. 8 during normal operation (upper row) and during spurious interference from a blocker (lower row).

### DETAILED DESCRIPTION

A MoCA network maintains optimized point-to-point and broadcast links between all of the MoCA nodes. Since a link's channel characteristics may vary over time, the MoCA network will perform periodic link maintenance. In a MoCA network link maintenance operations (LMOs) include, inter alia, recalculation of Physical layer (PHY) parameters such as the modulation profile (defining the modulation and coding scheme (MCS) for the individual OFDM subcarriers) and transmit power. LMOs involve receiving probes at regular intervals and sending back probe reports to the transmitting MoCA node (LMO node).

However, if the channel conditions change in between LMO cycles, e.g. as a result of a high power interference in the received spectrum or burst noise, the link between MoCA nodes will suffer errors until the next LMO cycle. This can decrease the link quality and affect the bit-error rate of the data exchanged via the link. A full LMO cycle can take up to 1.5 minutes in a full MoCA specification 2.0 and 2.5 (jointly referred to MoCA specification 2.x) compliant network. In the planned MoCA specification 3.x the number of MoCA nodes will be higher, potentially making the time between LMO cycles and/or the time for one LMO cycle even longer.

Hence a MoCA link that is subject to high power (blocking/jamming) and/or bursty interference in the spectrum can suffer significant performance degradation in the presence of the interference. Ingress interference such as electro-magnetic interference (EMI)/radio frequency interference (RFI) is an ever increasing phenomenon in coaxial home networks, due to multitude of radio emissions from electronic equipment and adjacent communication signals (e.g. from 3GPP LTE based networks).

The MoCA specifications available today assume knowledge of the existence of interference and the knowledge/estimate of the interference magnitude, and the MoCA interference mitigation mechanisms to mitigate interference are either activated or deactivated. If activated, the MoCA interference mitigation mechanisms affect the performance on the link as they are in operation regardless of the presence/absence of interference on the link. The mechanisms defined in the MoCA specifications 2.x that can mitigate the effect of in-band ingress and spur noise for individual subcarriers and for all subcarriers, respectively, are Subcarrier Added PHY Margin (SAPM) and Received Level Added PHY Margin (RLAPM). The SAPM function allows a node to add a pre-specified PHY margin to each subcarrier's bitloading (SAPM value) whenever the aggregate received power levels (ARPLs) are below a pre-specified threshold (ARPL_THLD). The RLAPM function allows a node to add a specific global PHY margin (RLAPM) to all the subcarriers' bitloadings at each estimated ARPL.

The table below provides a summary of SAPM and RLAPM in response to burst noise affecting SNR and to blocking interference at the receiver, in which an off-frequency signal causes the signal of interest to be suppressed:

| | Burst Noise | Blocker | Comments |
|---|---|---|---|
| SAPM | ARPL above threshold: does not | ARPL above threshold: does not | Data rate degradation happens |
| | prevent impact on error rate | prevent impact on error rate | in specified conditions with or |
| | (but with higher total power | (but with higher ARPL there | without interference. |
| | levels there is lower chance | is lower chance for the impact) | Requires knowledge/assumptions |
| | for the impact) | ARPL below threshold, SNR | on SNR degradation and ARPL |
| | ARPL below threshold, SNR | degradation within margin: no | threshold for efficiency. |
| | degradation within margin: | error rate increase | More suitable for burst noise |
| | no error rate increase | Total power below threshold, | scenarios, less suitable for |
| | Total power below threshold, | SNR degradation above margin: | blockers. |
| | SNR degradation above margin: | reduces impact on error rate | |
| | reduces impact on error rate | | |
| RLAPM | SNR degradation within margin | SNR degradation within margin | Data rate degradation happens |
| | for the given GARPL: no error | for the given GARPL: no error | in specified conditions with or |
| | rate increase | rate increase | without interference. |
| | SNR degradation above margin | SNR degradation above margin | Requires knowledge/assumptions |
| | for the given GARPL: reduces | for the given GARPL: reduces | on SNR degradation per GARPL, |
| | impact on error rate | impact on error rate | for efficiency |

As will become more apparent from the following description, the various embodiments may be suitable to address degradation of the link performance due to interference without the need to make in-advance assumptions on a potential and expected impact of noise or a blocker on the signal-to-noise (SNR) of signal on a given link. Instead the exemplary embodiments may either directly/instantaneously respond to the change in the SNR of signals received at a node or estimate the impact on the SNR resulting from noise or a blocker, i.e. without waiting for the next LMO cycle. If no SNR degradation or noise/blocker presence is detected, the bitloading of the subcarriers on a link is not adjusted. Thus, the interference mitigation mechanisms proposed in this disclosure do not impact the data rate on the link between the MoCA nodes if no interference/blocker is present, unlike conventional solutions.

The embodiments discussed herein relate to essentially two different scenarios. The first scenario relates to a situation in which a MoCA node is capable of monitoring the SNR per subcarrier also outside LMO cycles. To put it different, in this first scenario, it is assumed that MoCA node can—for example continuously or periodically (in shorter intervals than the LMO interval)—monitor the SNR on individual subcarriers of the channel (or bonded channels) on a given link. This may involve the monitoring of signals conveying live traffic (e.g. video data) which is in contrast to probe signals as used for deriving the SNRs during LMO. In this scenario, the MoCA node can calculate the (updated) number of bits to be mapped to a modulation symbol of the given subcarrier (or the corresponding modulation scheme or number of symbols in the constellation of the modulation scheme (“modulation order”) for the given subcarrier) based on the monitored SNR for that given subcarrier, so as to determine an updated bitloading of the subcarriers of the channel. The bitloading (i.e. an indication of the number of bits per modulation symbol for each of the subcarriers) may he provided in form of a modulation profile. The MoCA node may further communicate the updated bitloading/modulation profile to a transmitting MoCA node to request the transmitting MoCA node to update the bitloading on the subcarriers accordingly. In one example, the process of updating the bitloading may be triggered in case the SNR of at least one of the subcarriers degrades relative to a previous SNR measurement, and accordingly, the number of bits to be mapped to a modulation symbol/modulation scheme of the one or more subcarriers for which a lowering of the SNR is detected is/are reduced according to the change in the respective SNR.

In the second scenario, the update of the bitloading/modulation profile for a channel by a MoCA node is based on variations in the total power of signals received. The MoCA node for example continuously or periodically (in shorter intervals than the LMO interval) monitors the total power at the input of the receiver for a given link. This may involve the monitoring of signals conveying live traffic. In this scenario, the MoCA node utilizes the monitored total power at the input of the receiver to estimate a change in the SNR on the channel. In one example, one SNR change may be estimate for all subcarriers of a channel (in contrast to determining individual SNR changes for individual subcarriers as in the first scenario). In this latter case, the update of the bitloading for the subcarriers of the channel may thus be uniform, i.e. the number of bits per modulation symbol is changed by the same number for each of the subcarriers of the channel.

Also in this second scenario, the MoCA node may calculate the (updated) number of bits to be mapped to a modulation symbol of the given subcarrier (or the corresponding modulation scheme or modulation order of the given subcarrier) based on the monitored total received power at the input of the receiver, so as to determine an updated bitloading of the subcarriers of the channel. The bitloading may be provided in form of a modulation profile. The MoCA node may further communicate the updated bitioading/modulation profile to a transmitting MoCA node to request the transmitting MoCA node to update the bitloading on the subcarriers accordingly. In one example, the process of updating the bitloading may be triggered in case the total power in the received spectrum increases relative to a previous measurement of the total power. Accordingly, the number of bits to be mapped to a modulation symbol/modulation scheme of the one or more subcarriers is/are reduced according to the change in the total power in the received signals at an input of the receiver.

Using the bitloading update according to either one of the two scenarios described in this disclosure, the error rate on a link can be maintained within predetermined requirements (e.g. below a predetermined bit-error-rate) in the time period in between two LMO cycles, until the MoCA network readjusts the PHY parameters to the new channel conditions in the next LRM cycle.

The first scenario and the second scenario may be combined, e.g. by performing the update of the bitloading for a channel according to the second scenario, if the MoCA node cannot estimate/measure the SNR of individual subcarriers (e.g. at all or outside LMO periods). If the MoCA node can estimate/measure the SNR of individual subcarriers, the SNR-based update of the bitloading according to the first scenario should be used.

Furthermore, the embodiments may be advantageously used in a wideband receiver of a MoCA node. In a wideband receiver the input signals are sampled by the analog-digital converter (ADC) at the RF frequency (i.e. without down-conversion to baseband (or intermediate frequency)). Alternatively, the receiver may also be a narrow-band receiver where the signals are down-converted to baseband (or intermediate frequency) and channel filtering is used prior to sampling by the ADC.

Any of the operations, processes, etc. described herein may be implemented as computer-readable instructions stored on a computer-readable medium. The computer-readable instructions may, for example, be executed by a processor of a mobile unit, a network element, and/or any other computing device.

Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data. Computer storage media may include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing devices, such as processors, CPUs and the like.

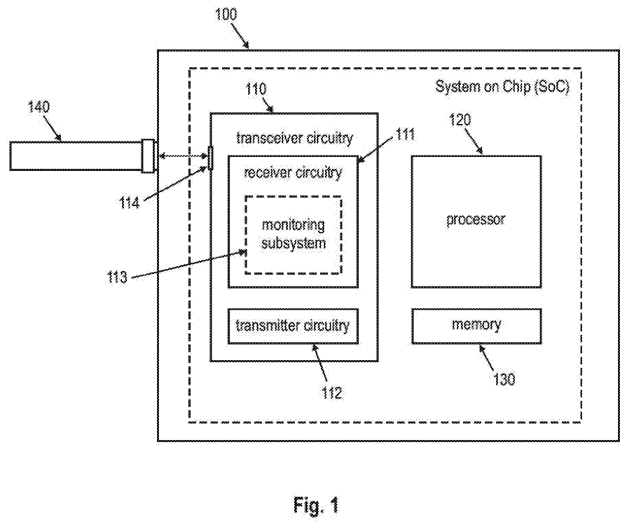

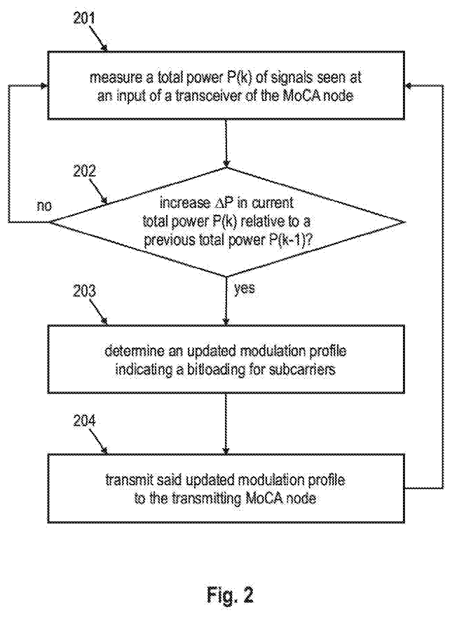

FIG. 1 shows a MoCA node 100 according to embodiments of this disclosure. An exemplary operation of the MoCA node 100 in FIG. 1 is highlighted in the flow chart of FIG. 2. The MoCA node 100 comprises a monitoring sub-system 113. The monitoring subsystem 113 may be part of a receiver circuitry 111. The MoCA node may also include a transmitter circuitry 112. The receiver circuitry 111 and transmitter circuitry 112 may be part of a transceiver circuitry 110 comprises in the MoCA node 100. The transceiver circuitry 110 may be connected to include an input/output port (or connector). In an example, the input/output port (or connector) of the MoCA node 100 may be connected to a coaxial cable 140 to connect the MoCA node 100 to a MoCA network (not shown).

The monitoring subsystem 113 monitors 201 the total power of (all) signals seen at an input 114 of a transceiver circuitry 110 (more precisely, the receiver circuitry 111 thereof) of the MoCA node 100 and obtains a total power value at each measurement occasion. The monitoring subsystem 113 may perform periodic measurements of the total power of (all) signals seen at an input 114 of a transceiver circuitry 110 (more precisely, the receiver circuitry 111 thereof). Alternatively or in addition thereto, the monitoring subsystem 113 may perform measurements of the total power of (all) signals seen at an input 114 of a transceiver circuitry 110 (more precisely, the receiver circuitry 111 thereof) in response to a trigger.

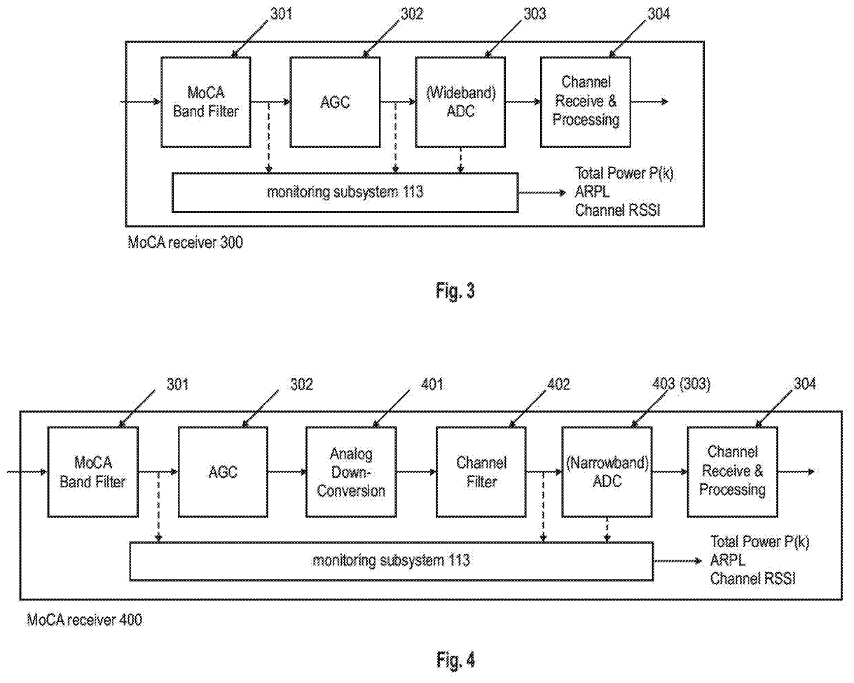

In one example, the total power represents the total power as seen by the receiver circuitry 111 in its inputs signal prior to automatic-gain control (AGC), i.e. at the input of the AGC component of the MoCA node 100 (see FIGS. 3 and 4). There are different possibilities on how the monitoring subsystem 113 can determine the total power seen at its input. One possibility is that there is circuitry provided to measure the power of the signal prior to AGC, which would directly provide the desired measurement result. However, it would also be possible to determine the power after AGC of the input signals, e.g. by measuring the power of the amplified input signals prior to analog-to-digital conversion (ADC) (see FIGS. 3 and 4). In this case, the total power at the input of the AGC could be determined by dividing the measured total power at the input of the ADC by the gain factor of the AGC (or subtracting the two values when working on logarithmic scale). Another implementation may be to determine the total power at the input of the AGC in the digital domain, i.e. by having a digital signal processing component (e.g. component 304 in FIGS. 3 and 4) determine the total power based on the sampled (i.e. digital) signals provided by the ADC and dividing it by the gain factor of the AGC in the digital domain (or subtracting the two values when working on logarithmic scale). It should be noted that the disclosure should not be construed as limiting the monitoring and measurement of the total power of (all) signals seen at an input 114 of a transceiver circuitry 110 (more precisely, the receiver circuitry 111 thereof) to these example, but this disclosure also contemplates alternative implementations for determining the total power within the skilled person's common knowledge.

The monitoring subsystem 113 may also monitor other PHY parameters, e.g. one or more of SNR values of the individual subcarriers corresponding to the channel(s) within the spectrum portion filtered by MoCA band filter 501, an Aggregate Receive Power Level (ARAM) of the subcarriers of the monitored channel or bonded channels, or a Received Signal Level (RSL) for the channel or bonded channels).

The MoCA node 100 further includes a processor 120 that detects an increase in the current total power value monitored by the monitoring subsystem 113 relative to a previously monitored total power value. The processor 120 may be coupled to the monitoring subsystem 113. The monitoring subsystem 113 may also include processing capabilities that allow the monitoring subsystem 113 to detect an increase in the current total power value monitored by the monitoring subsystem 113 relative to a previously monitored total power value. In this latter case, the monitoring subsystem 113 may inform the processor 120 on the amount of change in the total power value monitored by the monitoring subsystem 113 (which causes the processor 120 to detect an increase in the current total power value monitored by the monitoring subsystem 113 relative to a previously monitored total power value). Alternatively, the monitoring subsystem 113 may provide the processor 120 with the total power value measured and the processor 120 may detect an increase in the current total power value monitored by the monitoring subsystem 113 relative to a previously monitored total power value by comparing current and previous total power values reported by the monitoring subsystem 113.

In response to detecting an increase in the total power value monitored by the monitoring subsystem 113 relative to a previously monitored total power value (or upon being informed on such increase by the monitoring subsystem 113), the processor 120 determines an updated modulation profile indicating a bitloading for subcarriers to be used by a transmitting MoCA node (not shown) for transmissions on the subcarriers to the MoCA node 100. The determination is based on the detected increase in the current monitored total power value. The transceiver 112 (more precisely, the transmitter circuitry 112 thereof) transmits the updated modulation profile to the transmitting MoCA node 100.

In an example, the processor 120 determines an updated modulation profile only if the detected increase in the current total power value P(k) (with index k representing order of the measurements in time) relative to the previous monitored total power value P(k−1) exceeds a threshold value e.g. 2 dB, 3 dB, etc.). In another alternative example, the processor 120 is configured to determine an updated modulation profile only if the detected increase in the current total power value P(k) exceeds a threshold value for a predetermined number (N) of subsequent monitored total power values P(k−1), P(k−2), P(k−N). In another alternative example, the processor 120 is configured to determine an updated modulation profile only if the detected increase in the current total power value Pᵢ(k) exceeds a running average total power value Pₐᵥₑ=Σⱼ₌₁^{N}P(k−j)/N of a predetermined number (N) of previous monitored total power values P(k−1), P(k−2), . . . , P(k−N) by a threshold value. In the latter example, the previous monitored total power values P(k−1), P(k−2), . . . , P(k−N) could be also weighted (for example based on age).

An exemplary and more detailed implementation of a receiver circuitry 111 as used in MoCA node 100 is shown in FIG. 3. The receiver circuitry 300 is an example of a wideband receiver. In some exemplary implementations, the receiver circuitry 300 of MoCA node 100 may include a MoCA band filter 301, which is for example a bandpass filter. The MoCA band filter 301 may be configured to filter the signals within a predetermined frequency range. The filtered frequency range may correspond to the frequency range of a MoCA band. The receiver circuitry 300 may be operable in (tunable to) different MoCA bands (e.g. Band D, Extended Band D, Band E or Band F_{CBL} or Band F_{SAT}), each of which is associated with a predetermined frequency range. The receiver circuitry 300 may further include a component 302 for automatic gain control (AGC). The AGC 302 which receives the filtered frequency range provided from the MoCA band filter 301 and applies a gain factor to the signals in the filtered frequency range. Notably, the AGC 302 will amplify the signals comprised in the filtered frequency range, and may thus amplify wanted signals, noise, blocker signals, etc. in the filtered frequency range. The receiver circuitry 300 may further a component 303 for analog-to-digital conversion (ADC). The AGC 302 provides the amplified (analog) receive signals in the filtered frequency range to the ADC 303. The ADC 303 performs A/D conversion of the signals in the full filtered frequency range (spectrum). For example, ADC 303 samples the analog signals of in the time domain. The thus samples digital signals thus contain all signal components (inter alia including interference) in the filtered frequency range. The ADC 303 provides the sampled digital signals to component 304 that performs the digital signal processing. The signals may be OFDM signals and may thus undergo the conventional receiver side processing, e.g. including serial-to-parallel conversion, DFT/FFT processing, demodulation of the subcarriers, decoding, etc.

Please note that FIG. 3 exemplarily shows monitoring subsystem 113 as part of receiver circuitry 300, and indicates possible measurement points for obtaining the total power measurements in line with the previous discussion by means of the clashed arrows. As noted, these possible measurement points are exemplary only, and also the monitoring subsystem 113 could also not be integrated into the receiver circuitry 300.

Another exemplary and more detailed implementation of a receiver circuitry 111 as used in MoCA node 100 is shown in FIG. 4. In contrast to FIG. 3, FIG. 4 shows a narrow-band MoCA receiver 400. The received signals are filtered by MoCA filter 301. As noted in connection with FIG. 3 the MoCA filter 301 may ensure that only signal components in a frequency range corresponding to a MoCA band pass through the filter. The filtered signals output by the MoCA band filter 301 are received at an AGC component 302, which is similar to that in FIG. 3. AGC 302 applies a variable gain thereby amplifying the signals that have passed the band filter. In contrast to FIG. 3 the amplified signals are then provided to a. down-conversion element 401. The down-converter 401 mixes the amplified and hand-filtered receive signals at the radio frequency (RF) transmit frequency with a baseband frequency (or intermediate frequency), so as to be able to process the received signals in baseband (or the intermediate frequency). The down-converted signals are then provided to a channel filter 402. Channel filter 402 filters the down-converted signals (e.g. using a low-pass filter) so as to obtain only the signals that are within a given frequency range corresponding to one channel or a bonded channel in a MoCA band. The channel-filtered output of the channel filter 403 is provided to the ADC 403. Functionality-wise, ADC 403 in FIG. 4 is similar to the ADC 303 in FIG. 3, except that the amplified the signals in the remaining frequency range after channel filtering are subjected to A/D conversion, The digital samples thereof are provided to the component, 304 that performs the digital signal processing, as explained in connection with FIG. 3.

The MoCA receiver circuitry 300 and the MoCA receiver circuitry 400 as shown in FIGS. 3 and 4 may be for example implemented by a combination of an filter front end (comprising e.g. the MoCA band filter 301 and optionally the channel filter 402, and the AGC component (e.g. including a power amplifier)) and an integrated circuit (IC) controlling transmit and receive operation. Optionally the combination may also include a baseband. processor. The receiver front end may comprise one or more fixed gain stages, one or more variable gain stages, and/or one or more filters, depending on its design. Furthermore, in case of a narrow-band receiver structure, such as MoCA receiver circuitry 400, the combination may also comprise one or more up/down frequency conversions (e.g. double, conversion receiver for a heterodyne receiver design).

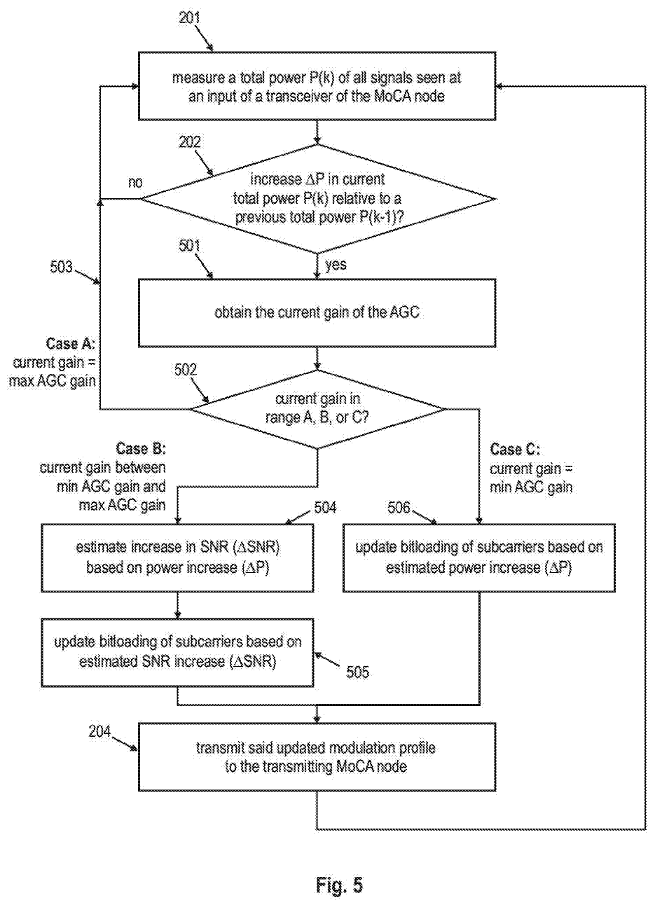

An exemplary operation of MoCA node 100 having a receiver circuitry 300 or a receiver circuitry 400 as shown in FIG. 4 is shown in the flow chart of FIG. 5. The first two steps shown in FIG. 5 are similar to the first two steps of FIG. 2. As noted, the MoCA node 100 may comprise an AGC component 302 to perform automatic gain control of the signals seen at the input of the MoCA node 100. The processor 120 may obtain 501, in response to detecting 202 an increase in the current monitored total power, the gain of the AGC component 302. Depending 502 on the gain, the processor 120 may react differently.

### Case A: AGC at Maximum Gain

If the gain is at a maximum gain value 503 of the ADC 302 (Case A), the processor 120 does not determine an updated modulation profile. In other words, there is no update of the bitloading. This is because it can be assumed that when AGC 302 is at the maximum gain, the signal level at the ADC input is at or lower than the target back-off, and the increase in total received power will either will or will not get the ADC input to the target back-off. If the increase in total received power does get the input signal level to the target back-off at ADC input then the AGC 302 will move to its normal operation range (between the minimum and maximum ADC gain, as descried herein below). Otherwise the AGC remains in maximum gain, and in this case signal degradation may not occur (i.e. the error rate may not change).

Case B: AGC between Minimum Gain and Maximum Gain

If the gain is within a range between a minimum gain value and a maximum gain value, i.e. in the normal operation range of the AGC 302 (Case B), the processor 120 may estimate 504 a change ΔSNR in the SNR for the subcarriers (of the channel or bonded channels) based on the detected increase ΔP(k) in the current monitored total power value P(k). The processor 120 may then update 505 the bitloading of subcarriers based on the estimated SNR increase ΔSNR. Stated differently, the processor 120 may determine a change of the updated modulation profile based on the estimated change in the SNR (ΔSNR). It should be noted that in view of the processor 120 reacting to an increase in the total power at MoCA receiver's input, the SNR of the subcarriers may be assumed to degrade. Accordingly, the updated modulation profile may indicate a reduction of the bits per modulation symbol for each of the subcarriers. Further, the change ΔSNR nay be determined for all subcarriers. Hence, the reduction of the number of bits per modulation symbol is uniform for all subcarriers in this latter case.

In general, it is noted that in case the reduction of a number of bits for to be mapped to a given subcarrier yields that no bits can be mapped to the subcarrier after the update, this means that the given subcarrier is no longer to be used for communication between the MoCA node 100 and the transmitting node. In other words, if for a given subcarrier the difference of a current number of bits per symbol on that subcarrier minus the reduction is equal to or smaller than zero, the subcarrier should no longer be used for transmission. The “non-use” of a subcarrier may be indicated by setting the number of bits for the given subcarrier to 0 (zero) in the modulation profile.

If the gain is within a range between a minimum gain value and a maximum gain value, the signal level at the ADC input can be assumed to be at the target back-off as defined in the receiver design, and the AGC 302 has the sufficient range to compensate for the increase in the gain (unless the blocker causes the AGC attenuation to reach its maximum, which will lead to Case C described below). Increasing attenuation (=reducing gain by AGC 302) as a result of higher input power would lead to an increase of the NF (Noise Figure) of the receiver 300, 400. The level of the NF degradation may be dependent of the total received. power level. One possibility for estimating the impact of the increase ΔP=P(k)−P(k−1) in the total power at receiver input on the change of the SNR may be to estimate the SNR decrease ΔSNR as the increase in the noise figure. For example assuming that Ptotal_{BP} is the total power at the receiver input 114 with interference (e.g. a blocker) being present (corresponding to the current total power measurement), whereas Ptotal_{BNP} is the total power at the receiver input 114 with no interference (e.g. no blocker) being present (corresponding to the previous total power measurement), the (corresponding to the previous total power measurement) SNR degradation ΔSNR due to noise figure can be estimated 504 as:

ΔSNR[dB]=NF(Ptotal_{BP})−NF(Ptotal_{BNP})

In one example, when the AGC 302 is within its operation range, it is reasonable to assume a dB-per-dB degradation of noise figure, and therefore SNR) vs. the applied attenuation of the AGC 302 (it is noted that this assumption may not apply to all receiver designs, i.e. the increased AGC attenuation may not necessarily result in dB-per-dB degradation over the entire AGC gain range), so that the SNR degradation ΔSNR may also be estimated 504 as follows:

ΔSNR[dB]=Ptotal_{BP}−Ptotal_{BNP}

Furthermore, assuming for sake of argument a 3 dB difference between the SNR required for demodulation of a signal of given modulation order vs. signal that is one modulation order lower, at a given error rate, the reduction Δbits in the number of bits to be mapped to the respective subcarriers (“bitloading adjustment”) due to interference/blocker may be determined in step 505 as follows:

$$Δ bits = roundup ( \frac{Δ SNR}{3} )$$

It should be noted that in sonic conditions, the drop in SNR will not mandate lowering the bitloading. For example, if the SNR is high enough and has more than 3 dB margin over the SNR required for the highest bitloading, or added PHY margin is used, the processor 120 may decide not to change the bitloading of the subcarriers, even though there is an increase in the total power at the receiver input (i.e. ΔP=Ptotal_{BP}−Ptotal_{BNP}>0). Nevertheless, if the exact SNR per subcarrier is not known and cannot be estimated, and only the bitloading per subcarrier is known to the receiver 300, 400, it is not possible to reduce bitloading according to the received SNR, but only according to an estimated change in SNR (ΔSNR). Therefore, the proposed operation of the receiver 300, 400 may result in cases where bitloading of the subcarriers will be reduced even though this would not be necessary. This may temporarily impact the data rate, but it can be ensures that the data transmission via the link between MoCA node 100 and the transmitting node will operate within the allowed error rate requirements until the next periodic LMO. The error rate requirements referred to herein may be for example given as a normal packet error rate (NPER) and/or a very low packet error rate (VLPER) defined in a MoCA network for a given channel or bonded channels. At the next LMO, the modulation profiles will be re-calculated to achieve the optimal throughput again. In one example, the error rate for VLPER is equal to 10⁻⁸, and the error rate for NPER is equal to 10⁻⁶, but this is just one example. Notably, the error rate for NPER is higher than the error rate for VLPER as their names suggest.

Case C: AGC at Minimum Gain

Finally, if the gain is at a minimum gain value (Case C), the processor 120 determines 506 the updated modulation profile based on the detected increase (ΔP) in the current monitored total power value.

The AGC 302 will be at minimum gain if signal level at the ADC's 303, 404 input is at or higher than the target back-off from ADC full-scale input. The AGC 302 may thus not compensate an increase in the total power at the receiver input 114, and the power increase, may thus propagate to the ADC input, causing clipping. The probability and severity of clipping for a given signal may depend on the signal characteristics such as PAR (Peak to Average Ratio) and the back-off that is taken from the ADC full-scale input. Depending on the difference in the measured total power, the number of bits per subcarrier may be reduced in order to increase resilience against clipping at the ADC 302 (clipping could in turn effect the error rate). For example, a system designer might find that the power level at the ADC input that is 3 dB higher than intended (meaning 3 dB lower back-off from the ADC full-scale input) causes clipping that violates the error rate requirements. The designer of the receiver stage may find (e.g. using simulations or measurements) that in order to reduce the error rate of the link back to allowed levels, the modulation order should be reduced by two (i.e. two bits less per symbol would need to be sent). Contrarily, when the total power at the ADC input is 1 dB higher that intended, this situation may not cause violation of the error rate requirements (this is an arbitrary example and it may or may riot reflect real scenarios). Hence, the required decrease in the modulation order and hence the update of the bitloading for the case of an increase in the monitored total power at the receiver input while the AGC 302 is at minimum gain may be depending on the implementation of the receiver 300, 400 and its design. The system designer may for example implement a lookup-table or function for determining 506 the required reduction in bits (bitloading adjustment) for different levels of increase (ΔP) in the current monitored total power value based on the characterization of the receiver performance at different input power levels. Alternatively, the lookup-table or function may also map given levels of violation of the back-off (due to increase (ΔP) in the current monitored total power value) to a corresponding bitloading adjustment based on the characterization of the receiver performance at different input power levels.

Upon having determined the bitloading adjustment in step 505 or 506, the updated modulation profile is sent 204 to the transmitting MoCA node.

In one example, the transmission of the updated modulation profile in step 204 of FIGS. 2 and 5 uses an unsolicited EVM Probe Report LMO message or another unsolicited message for transmitting the updated modulation profile from the MoCA node 100 to the transmitting node. The modulation profile may for example indicate, for a unicast link, a normal packet error rate (NPER) bitloading scheme and a very low packet error rate (VLPER) bitloading scheme for the subcarriers. For an OF DMA bitloading profile, the, modulation profile may optionally indicate a sequence number and updated subchannel definition tables and subchannel assignment tables in addition to the bitloading scheme.

In another example of the second aspect discussed above, which may be considered an improvement of the procedure in FIG. 5, in addition to the AGC gain and input total power P(k) the receiver circuitry 111, 300, 400 may also be aware of the RSL (Received Signal Level) of each of the channels. The RSL can be used to estimate the current SNR of the channel subcarriers, in addition to the total power P(k). Moreover, the SNR that was measured during the last regular LMO cycle may also be used as an estimation of the current SNR. In both cases the SNR estimation could be used to estimate how susceptible the channel performance is to a change in the AGC gain state. The susceptibility level estimation may be used in step 505 to decide on the required bitloading adjustment. For example, the system designer may decide that if according to the SNR estimation there is sufficient margin over the SNR that is required for operation of all subcarriers at the highest modulation order, then there is no need to adjust the bitloading for that channel even if the SNR is expected to degrade due to total power increase.

In another exemplary scenario, the system may already operate under an SNR margin such as in the case of SAPM/RLAPM modes configured and active under the given conditions. In an example of the first and the second aspects discussed above, the system may detect an increase in total power of 3 dB and estimate SNR degradation of 3 dB. But since there is already 4 dB margin taken, then there may not be a need to further adjust the bitloading as the existing margin can accommodate the estimated degradation. In other words, the reduction Δbits in the number of bits due to the SNR degradation ΔSNR and the existing SNR margin M_{SNR} can be determined as follows:

$$Δ bits = roundup ( \frac{Δ SNR - {M}_{SNR}}{3} )$$

If the result of the calculation of Δbits is 0 (zero) or a negative number this means that no change in the bitloading (modulation profile) is required.

In the examples above, the MoCA node 100 sends an updated modulation profile to the transmitting node. In another example, the MoCA node 100 may combine the update of the modulation profile with a transmission power control command to the transmitting node. In this example, the MoCA node 100 may cause an increase of the transmission power of the transmitting node to improve the received signal SNR at the MoCA node 100. This may allow for “lowering” the decrease in the modulation order when calculating the new bitloading for the channel or bonded channels (see steps 203 and 505) the MoCA node 100, so that the overall data rate of the transmission data can be maintained at a higher level, while still meeting the error rate constraints for the transmission of the data. For example, in case the update of the modulation order would require for reducing the number of bits per modulation symbol by 3 bits, the increase of the transmission power at the transmitting node by using a power control command may allow reducing the number of bits per modulation symbol by 2 bits only, while still meeting the error rate defined for the link.

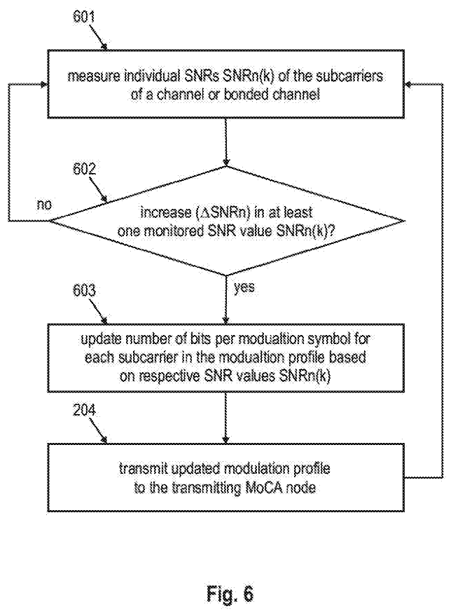

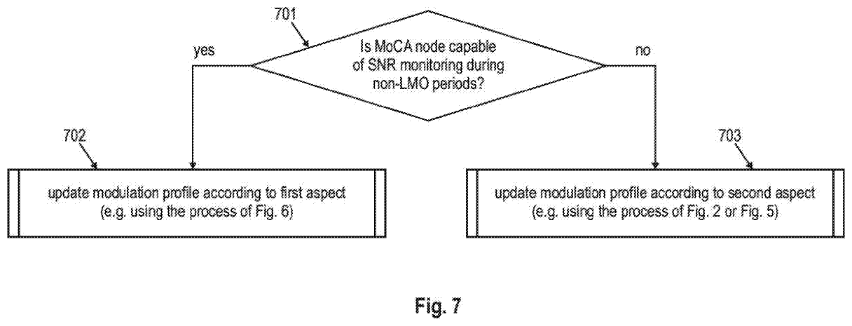

While the above paragraphs mainly focus on the concepts summarized as the second aspect of this disclosure outlined above, the concepts of the first aspect above will be now highlighted in further detail. As noted, in the first aspect, the MoCA node is capable of monitoring (measuring) the SNR of the individual subcarriers on a link between MoCA node and a transmitting node communicating transmission data to the MoCA node. FIG. 6 shows an exemplary flow chart of an operation of a MoCA node according to the first aspect of this disclosure.

In an embodiment, the MoCA node may be structured essentially similar to the MoCA node 100 in FIG. 1, and may include a receiver circuitry 300 or 400 as shown in FIGS. 3 and 4. Different from the MoCA node 100 described herein above, the monitoring subsystem 113 of MoCA node 100 may not be able to measure the total power at the input 114 of its transceiver circuitry 110 (or more precisely the receiver circuitry 111, 300, 400)—but the, MoCA node 100 may also still be capable to measure the total power at the input 114 of its transceiver circuitry 110. In the first aspect, the monitoring subsystem 113 is capable of measuring 601 the SNR on each of the subcarriers to obtain a current SNR value SNRₙ(k) (with index k representing order of the SNR measurements in time) for each of the subcarriers (subcarrier index n∈{0,1, . . . , M−1} with M being the total number of subcarriers, for example, on a. channel or on bonded channels). These SNR measurements may be performed during non-LMO periods. These SNR measurements may be performed for each channel. Hence, if there are bonded channels, SNR may be measured for the subcarriers on each of the bonded channels separately.

The monitoring subsystem 113 may perform periodic SNR measurements based on the signals seen at an input 114 of a transceiver circuitry 110 (more precisely, the receiver circuitry 111 thereof), Alternatively or in addition thereto, the monitoring subsystem 113 may perform SNR measurements in response to a trigger.

The MoCA node 100 further includes a processor 120. Optionally, the processor 120 may detect 602 an increase ASNR, in at least one SNR value SNRₙ(k) monitored by the monitoring subsystem 113 relative to a previously monitored SNR value SNRₙ(k−1). The processor 120 may be coupled to the monitoring subsystem 113. The monitoring subsystem 113 may also include processing capabilities that allow the monitoring subsystem 113 to detect an increase ΔSNRₙ in at least one SNR value SNRₙ(k) monitored by the monitoring subsystem 113 relative to a previous SNR value SNRₙ(k−1). In this latter case, the monitoring subsystem 113 may inform the processor 120 on the amount of change in the SNR values a respective amount of chance ΔSNRₙ for all M subcarriers) monitored by the monitoring subsystem 113 (which causes the processor 120 to detect 602 an increase ΔSNRₙ in at least one SNR value SNRₙ(k) monitored by the monitoring subsystem 113 relative to a previous SNR value SNRₙ(k−1)). Alternatively, the monitoring subsystem 113 may provide the processor 120 with the SNR values SNRₙ(k) measured for the subcarriers and the processor 120 may detect 602 an increase ΔSNRₙ in the at least one SNR value SNRₙ(k) monitored by the monitoring subsystem 113 relative to the corresponding previous SNR value SNRₙ(k−1) of the respective subcarrier by comparing current and previous SNR values reported by the monitoring subsystem 113.

If there is an increase ΔSNRₙ, the processor 120 may update 603 the number of bits per modulation symbol for each of the subcarriers based on the respective SNR. values SNRₙ(k) for each subcarrier n. Alternatively, the update may be based on the relative increase ΔSNRₙ of the at least one SNR value SNRₙ(k) relative to the corresponding previous SNR value SNRₙ(k−1) for the respective subcarriers. As noted the subcarriers may belong to a single channel or to bonded channels. The MoCA node 100 uses its transceiver circuitry 110 to transmit 204 the updated modulation profile indicating the respective updated numbers of bits per modulation symbol for each of the subcarriers to the transmitting node.

In one example, the transmission of the updated modulation profile in step 204 of FIG. 6 uses an unsolicited EVM Probe Report LMO message or another unsolicited message for transmitting the updated modulation profile from the MoCA node 100 to the transmitting node. The modulation profile may for example indicate, for a unicast link, a normal packet error rate (NPER) bitloading scheme and a very low packet error rate (VLPER) bitloading scheme for the subcarriers. For an OFDMA bitloading profile, the modulation profile may indicate a sequence number and updated subchannel definition tables and subchannel assignment tables in addition to modulation scheme.

In one exemplary implementation of step 603 of FIG. 6, the subcarriers have an index 71, and the respective channels have an index m. In this example, an updated modulation profile is determined by processor 120 for a NPER bitloading scheme and a VLPER bitloading scheme as follows.

BL_new_{NPER}(n, m)=Bitloading_{NPER}[SNR_{n,m}(k)]

BL_new_{VLPER}(n, m)=Bitloading_{VLPER}[SNR_{n,m}(k)]

Where SNR_{n,m}(k) is the current SNR value measured for subcarrier n in channel k, Bitloading_{NPER}[ . . . ] and Bitloading_{VLPER}[ . . . ] are mapping functions that calculate the new bitloading (number of bits per OFDM symbol) BL_new_{NPER}(n, m) and BL_new_{VLPER}(n, m) for subcarrier n in channel k based on the current SNR value.

As noted, the first and second aspect can be combined with one another. Such combination is exemplarily highlighted in the flow chart of FIG. 7. The MoCA node 100 (e.g. the processor 120 thereof) may determine 701, if the MoCA node 100 is capable of monitoring the signal to SNR on the subcarriers during non-LMO periods. If so, the MoCA node 100 may determine 702 the updated modulation profile based on the individual SNR values for the subcarriers, for example, using one of the various procedures highlighted in connection with FIG. 6 above. If the MoCA node 100 is not capable of monitoring the SNR on the subcarriers during non-LMO periods, the processor 120 may use 703 the monitored total power values for the update of the modulation profile. In this latter case, one of the different exemplary procedures outlined in connection with FIGS. 2 and 4 herein above may be used.

In the following, potential problems associated with spurious changes in the interference on a link between MoCA nodes during communication (i.e. outside an LMO period) will be outlined for a better understanding of potential advantages that the embodiments related to the first and second aspects of this disclosure can provide. One of the reasons for SNR degradation on a link can be an appearance of a blocker at a frequency that is seen by the front end (meaning that the frequency is passed by the MoCA band filter 301). The ADC 302 is commonly designed to operate optimally with a specified constant power at its input (at a specified back-off from the input full-scale). The gain of the AGC 302 may be adjusted to get the power at the AGC input to the target power level. The appearance of the blocker (implying an increased total power at the receiver input 114) will normally cause the AGC 302 to re-adjust to the new received total power by increasing attenuation (=reducing gain) before the ADC 403, 303, in order to get the signal to the ADC input at the target level. The increased attenuation in the AGC 302 may increase the noise figure of the receiver 111, 300, 400, which in some conditions is the limiting factor on the SNR measured by the monitoring subsystem 113 of the MoCA node 100.

In receiver architectures similar to those in FIG. 4 that use a frequency down-converter 401 before sampling (by ADC 403), a blocker signal within the diplexer pass-band (MoCA filter 301) will still likely be filtered to some extent by channel filters 402 before ADC. Hence, if the interference is very close to the channel or inside the channel bandwidth, the blocker signal is still part of the filtered signal provided to the narrow-band ADC 403. In a wideband sampling receiver 300 as for example shown in FIG. 3 the ADC 303 will see the pop-up interference at its input, if it is anywhere within the allowed MoCA band, regardless of how close or far the interference appears from the desired channel. Therefore the impact of interference on the SNR degradation may be more severe in wideband sampling receivers as exemplified in FIG. 3.

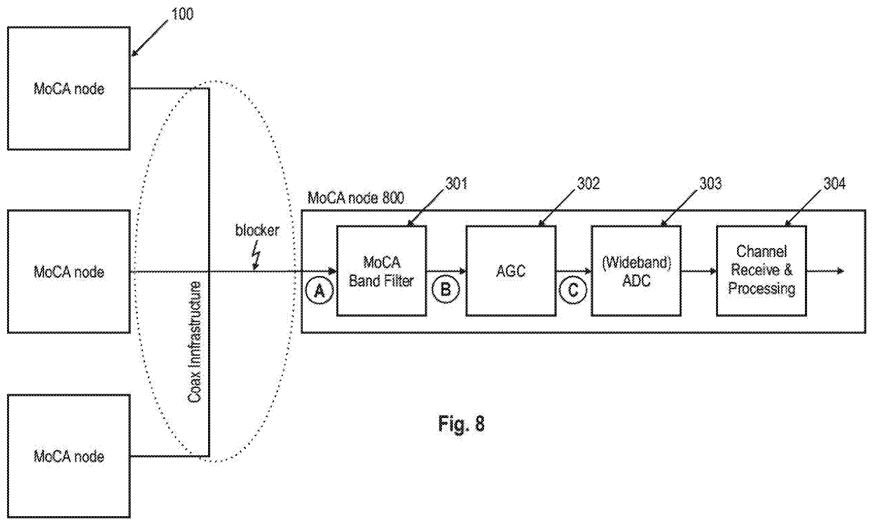

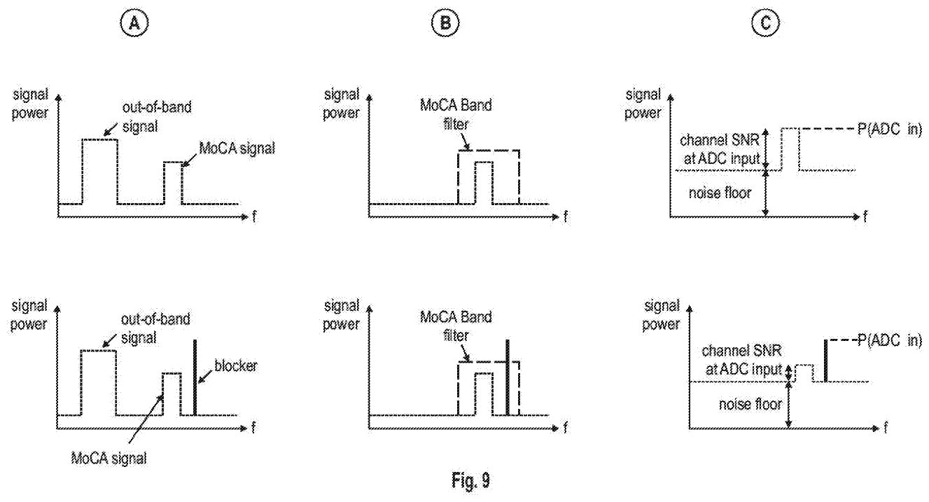

This will be explained in connection with FIGS. 8 and 9 in more detail. FIG. 8 shows a MoCA network in width multiple MoCA nodes 100, 800 are connected via a coax infrastructure. In-home coaxial networks are often configured as a branching tree topology with the point of demarcation being at the Point of Entry (PoE), although this disclosure is not limited to such MoCA network topology. The PoE is typically connected to the first splitter (not shown) in the home at the point called root node through a coax cable. The root node is the common port of the first splitter from which all the MoCA nodes 100, 800 can be reached by traversing only through the forward paths of splitters. In order to get video and/or broadband data services, the root node is connected to a multi-tap in the cable Multiple Systems Operator's coax distribution plant. The MoCA nodes 100, 800 may communicate with each other by having their communication signals traverse across one or more splitters provided in the coax infrastructure.

In FIG. 8, MoCA node 800 is assumed to be a receiving node that receives signals from MoCA node 100 via the coax infrastructure. The MoCA node 800 is assumed to have a wideband receiver similar to that in FIG. 3. In this receiver structure, point A denotes the MoCA receiver input before MoCA band filter 301, point B denotes the filtered signal at the AGC input. All signals that are still present after the MoCA band filter 301 will be affected by the AGC 302 gain. Point C denotes the ADC 303 input. The total root mean square (RMS) power at the ADC input should be kept at specified back-off from ADC full-scale by AGC 302.

FIG. 9 illustrates the power (in logarithmic scale/dB) of the received signals on the y-axis and the signal frequency on the y-axis for the different reference points A, B and C (from the left to the right). The upper row in FIG. 9 illustrates the signals for the normal operation case, i.e. where no spurious interference, e.g. a blocker signal, is present. The lower row in FIG. 9 illustrates the signals for an operation case, where a blocker signal is present.

As can be seen in the upper row in FIG. 9, in case of “normal operation” the input to the MoCA band filter 301 may comprise the desired signal in the spectrum of one of the MoCA bands (“MoCA signal”) and also other out-of-band signals. The MoCA band filter 301 filters those out-of-band signals so that only the spectrum corresponding to a given MoCA band including the desired MoCA signal is provided to the input of AGC 302 (reference point B). The amplification/gain of AGC 302 will increase not only the signal level of the MoCA signal, but also all other signals (e.g. noise), so that the noise floor (NT) is raised at the input of ADC 303 (reference point C). Yet, the SNR at reference point C is still in an acceptable level and the total power input to the ADC 303 (P(ADC_in) is governed by the MoCA signal.

As shown in the lower row in FIG. 9, if is a blocker signal within the MoCA band (not necessarily in the channel of interest corresponding to the MoCA signal) at the input at reference point A of the MoCA band filter 301, the blocker signal will propagate through the MoCA band filter 301 and will be also input to the AGC 302 at reference point B. Hence, AGC will amplify the blocker signal component, which can lead to a significant increase in the noise floor relative to the MoCA signal. This may cause significant reduction in the channel SNR at reference point C, i.e. the ADC 303 input. Moreover, the blocker signal will also dominate the power domain of the signals input to the ADC 303 and thus may cause a significant increase in the total power input to the ADC 303 (P(ADC_in). The above described concepts of the first and second aspect may mitigate these effects discussed in connection with blockers appearing in the receiver input.

In the embodiments of the different aspects discussed in this disclosure, once the modulation profile update has been sent to the transmitting MoCA node, the transmitting node may provide the updated modulation profile to other MoCA nodes receiving transmissions from the transmitting MoCA node (e.g. in case of a point-to-multipoint transmission). The message exchange for updating modulation profiles at other nodes may for example be designed similar to the message exchanges described for LMO in section 8.9.9.2 of MoCA 2.5 PHY specifications.

in some implementations, the profile update described above may not utilize any proprietary messages or data, but may rely on already defined messages and procedures in the MoCA specification 2.x. The updated profiles may thus be constructed according to MoCA specifications 2.x, and may thus be compatible with the profiles maintained during regular LMO. The profile distribution is done reusing an LMO procedures in the MoCA specification 2.5 (see section 8.9.2.2 of the MoCA 2.5 specifications).

Thus, the MoCA node 100 that implements the first and/or second aspect of this disclosure using an Unsolicited EVM Probe Report LMO message to update the modulation profile at the transmitting MoCA node may be able to update the transmission profile of any MoCA 2.x compliant node, regardless of whether that node implements the aspects discussed herein.

### Additional Examples

Additional Example 1 provides a MoCA node comprising: a monitoring sub-system to monitor a total power of all signals seen at an input of a transceiver of the MoCA node to obtain a total power value; and a processor to detect an increase in a current monitored total power value relative to a previous monitored total power value. The processor is configured to determine an updated modulation profile indicating a bitloading For subcarriers to be used by a transmitting MoCA node for transmissions on said subcarriers to the MoCA node, said determination being based on the detected increase in the current monitored total power value. The transceiver is configured to transmit said updated modulation profile to the transmitting MoCA node.

Additional Example 2 is based on the MoCA node of Additional Example 1, which further comprises an automatic gain controller (AGC) to perform automatic gain control of the signals seen at the input of the MoCA node; and the processor is configured to obtain, in response to detecting said increase in the current monitored total power, the gain of the AGC.

Additional Example 3 is based on the MoCA node of Additional Example 2, wherein, if the gain is within a range between a minimum gain value and a maximum gain value, the processor is configured to estimate a change in the signal to noise ratio (SNR) for said subcarriers based on the detected increase in the current monitored total power value and to determine said change of the updated modulation profile based on the estimated change in the SNR.

Additional Example 4 is based on the MoCA node of Additional Example 2 or 3, wherein, if the gain is at a minimum gain value, the processor is configured to determine said updated modulation profile on based on the detected increase in the current monitored total power value.

Additional Example 5 is based on the MoCA node of one of Additional Examples 2 to 4, wherein, if the gain is at a maximum gain value, the processor is configured to not determine an updated modulation profile.

Additional Example 6 is based on the MoCA node of one of Additional Examples 1 to 5, wherein the processor is configured to determine an updated modulation profile so that the signals transmitted from the transmitting node using the updated modulation provide achieve a target error rate at the MoCA node.

Additional Example 7 is based on the MoCA node of one of Additional Examples 1 to 6, wherein the transceiver comprises a receiver to receive said signals. The receiver may be a wideband receiver configured to sample the input signals by means of an analog-digital converter (ADC) without down-conversion to baseband or intermediate frequency.

Additional Example 7 is based on the MoCA node of one of Additional Examples 1 to 6, wherein the transceiver comprises a receiver to receive said signals. The receiver may be a narrow-band receiver configured to down-convert the signals to baseband or an intermediate frequency and apply channel filtering on the down-converted signals prior to sampling the channel filtered signals by means of an analog-digital converter (ADC).

Additional Example 9 is based on the MoCA node of Additional Example 8, wherein the receiver comprises a channel filter which extracts a frequency range from the down-converted signals corresponding to one channel or bonded channels from one of MoCA Band D, Extended Band D Band E or B or F_{CBL}, or Band F_{SAT}.

Additional Example 10 is based on the MoCA node of one of Additional Examples 7 to 9, wherein the receiver comprises a MoCA band filter configured to filter a frequency range corresponding to one of MoCA Band D, Extended Band D Band E or Band F_{CBL} or Band F_{SAT}.

Additional Example 11 is based on the MoCA node of one of Additional Examples 1 to 10, wherein the updated modulation profile indicates an updated number of bits per modulation symbol for each of the subcarriers.

Additional Example 12 is based on the MoCA node of Additional Example 11, wherein the, updated modulation profile indicates a reduction of the bits per modulation symbol for each of the subcarriers.

Additional Example 13 is based on the MoCA node of Additional Example 12, wherein the reduction is uniform for all subcarriers.

Additional Example 14 is based on the MoCA node of one of Additional Examples 1 to 13, wherein the transceiver is configured to transmit said determined updated modulation profile in an unsolicited EVM Probe Report UNTO message or another unsolicited message.

Additional Example 15 is based on the MoCA node of one of Additional Examples 1 to 14, wherein the modulation profile indicates for a unicast link, a normal packet error rate (NPER) bitloading scheme and a very low packet error rate (VLPER) bitloading scheme for the subcarriers.

Additional Example 16 is based on the MoCA node of one of Additional Examples 1 to 15, wherein the modulation profile indicates for an OFDMA bitloading profile, a sequence number and updated subchannel definition tables and subchannel assignment tables.

Additional Example 17 is based on the MoCA node of one of Additional Examples 1 to 16, wherein the processor is configured to determine an updated modulation profile only if the detected increase in the current monitored total power value relative to the previous monitored total power value exceeds a threshold value.

Additional Example 18 is based on the MoCA node of one of Additional Examples 1 to 16, wherein the processor is configured to determine an updated modulation profile only if the, detected increase in the current monitored total power value exceeds a threshold value for a predetermined number of subsequent monitored total power values.

Additional Example 19 is based on the MoCA node of one of Additional Examples 1 to 16, wherein the processor is configured to determine an updated modulation profile only if the detected increase in the current monitored total power value exceeds a running average total power value of a predetermined number of previous monitored total power values by a threshold value.

Additional Example 20 is based on the MoCA node of one of Additional Examples 1 to 19, wherein the monitoring sub-system is configured to periodically provide the processor with a current total power value.

Additional Example 21 is based on the MoCA node of one of Additional Examples 1 to 19, wherein the monitoring sub-system is configured to provide the processor with a current total power value in response to a trigger.

Additional Example 22 is based on the MoCA node of one of Additional Examples 1 to 21, wherein the processor is configured to store the current total power value and at least one previous total power value in a memory of the MoCA node.

Additional Example 23 is based on the MoCA node of one of Additional Examples 1 to 22, wherein the processor is configured to determine, if the MoCA node is capable of monitoring the signal to noise ratio (SNR) on each of the subcarriers during non-LMO periods; and, if so, to determine the updated modulation profile based on the individual SNR values for the subcarriers.

Additional Example 24 is based on the MoCA node of Additional Example 22, which further comprises a SNR monitoring sub-system configured to monitor an SNR on each of the subcarriers, to obtain a respective SNR value for each of the subcarriers.

Additional Example 25 is based on the MoCA node of Additional Example 22 or 24, wherein the processor is configured to determine an updated number of bits per modulation symbol for each of the subcarriers based on the respective SNR value for said respective, subcarrier, wherein the updated modulation profile indicates the respective updated numbers of bits per modulation symbol for each of the subcarriers.

Additional Example 26 is based on the MoCA node of one of Additional Examples 22 to 25, wherein the processor is configured to use the monitored total power values for the update of the modulation profile, if the MoCA node is not capable of monitoring the SNR on each of the subcarriers during non-LMO periods.

Additional Example 27 provides a method for adjusting the modulation profile for transmission between a MoCA node and a transmitting node, wherein the MoCA node performs: monitoring a total power of all signals seen at an input of a transceiver of the

MoCA node to obtain a total power value; detecting an increase in a current monitored total power value relative to a previous monitored total power value; determining an updated modulation profile indicating a bitloading for subcarriers to be used by a transmitting MoCA node for transmissions on said subcarriers to the MoCA node, said determination being based on the detected increase in the current monitored total power value; and transmitting said updated modulation profile to the transmitting MoCA node.

Additional Example 28 is based on the method of Additional Example 27, which further comprises: performing automatic gain control (AGC) of the signals seen at the input of the MoCA node; and obtaining, in response to detecting said increase in the current monitored total power, the gain of the AGC.

Additional Example 29 is based on the method of Additional Example 28, which further comprises: if the gain is within a range between a minimum gain value and a maximum gain value, estimating a change in the signal to noise ratio (SNR) for said subcarriers based on the detected increase in the current monitored total power value and determining said change of the updated modulation profile based on the estimated change in the SNR.

Additional Example 30 is based on the method of Additional Example 28 or 29, which further comprises: if the gain is at a minimum gain value, determining said updated modulation profile on based on the detected increase in the current monitored total power value.

Additional Example 31 is based on the method of one of Additional Examples 28 to 30, which further comprises: if the gain is at a maximum gain value, not determining an updated modulation profile.

Additional Example 32 provides one or more computer-readable media storing instructions that, when executed by a processor of a MoCA node, cause the MoCA node to adjust the modulation profile for transmission between a MoCA node and a transmitting node, by causing the MoCA node to: monitor a total power of all signals seen at an input of a transceiver of the MoCA node to obtain a total power value; detect an increase in a current monitored total power value relative to a previous monitored total power value; determine an updated modulation profile indicating a bitloading for subcarriers to be used by a transmitting MoCA node for transmissions on said subcarriers to the MoCA node, said determination being based on the detected increase in the current monitored total power value.

Additional Example 33 is based on the one or more computer-readable media of Additional Example 32, further storing instructions that, when executed by the processor of the MoCA node, cause the MoCA node to: performing automatic gain control (AGC) of the signals seen at the input of the MoCA node; and obtaining, in response to detecting said increase in the current monitored total power, the gain of the AGC.

Additional Example 34 is based on the one or more computer-readable media of Additional Example 33, further storing instructions that, when executed by the processor of the MoCA node, cause the MoCA node to: if the gain is within a range between a minimum gain value and a maximum gain value, estimating a change in the signal to noise ratio (SNR) for said subcarriers based on the detected increase in the current monitored total power value and determining said change of the updated modulation profile based on the estimated change in the SNR.

Additional Example 35 is based on the one or more computer-readable media of Additional Example 33 or 34, further storing instructions that, when executed by the processor of the MoCA node, cause the MoCA node to: if the gain is at a minimum gain value, determining said updated modulation profile on based on the detected increase in the current monitored total power value.

Additional Example 36 is based on the one or more computer-readable media of one of Additional Examples 33 to 35, further storing instructions that, when executed by the processor of the MoCA node, cause the MoCA node to: if the gain is at a maximum gain value, not determining an updated modulation profile.

It should be understood that many of the functional units (e.g. transceiver circuitry 110, receiving circuitry 111 and its units as exemplarily shown in FIGS. 3 and 4), transmitter circuitry 113, etc.) described in this specification may be implemented as one or more components, which is a term used to more particularly emphasize their implementation independence. For example, a component may be implemented as a hardware circuit or multiple hardware circuits, which may for example include custom very large scale integration (VLSI) circuits or gate, arrays, off-the-shelf semiconductors such as logic chips, transistors, operational amplifiers, programmable and variable amplifiers, monolithic or integrated filters, discrete component filters or other discrete components. A component may also be implemented in programmable hardware devices such as field programmable gate arrays, programmable array logic, programmable logic devices, or the like.

Components may also be implemented—at least in part—in software instructions for execution by various types of processors. For example, the process of collecting measurements and calculating the updated modulation profile could be implemented in form of a component of executable code (software instructions) to be executed by one or more processors of the MoCA node. This component of executable code may be for example part of the firmware of the MoCA node. An identified component of executable code may, for instance., comprise one or more physical or logical blocks of computer instructions, which may, for instance, be organized as an object, a procedure, or a function. Nevertheless, the executables of an identified component need not be physically located together, but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components, and may he embodied in any suitable form and organized within any suitable type of data structure. The operational data may be collected as a single data set, or may be distributed over different locations including over different storage devices, and may exist, at least partially, merely as electronic signals on a system or network. The components may be passive or active, including agents operable to perform desired functions.

A processor that can execute software instructions that at least in part implement a component may be realized for example by using a single-core or multi-core computer processing unit (CPU) or digital signal processor (DSP). However, the processing capabilities required may also be implemented by multiple processors and/or programmable hardware devices such as field programmable gate arrays, programmable array logic, programmable logic devices, or the like.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another, but are to be considered as separate and autonomous representations of the present disclosure.

In the above description of illustrated examples of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components or structures (assemblies, devices, circuits, systems, etc.), the terms (including a reference to a “means” or “units”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature may have been disclosed with respect to only one of several implementations, such feature may be combined with one or more other features of the other implementations as may be desired and advantageous for any given or particular application.

1-26. (canceled)

27. A MoCA node comprising:
a monitoring sub-system to monitor a total power of all signals seen at an input of a transceiver of the MoCA node to obtain a total power value; and
a processor to detect an increase in a current monitored total power value relative to a previous monitored total power value;
wherein the processor is configured to determine an updated modulation profile indicating a bitloading for subcarriers to be used by a transmitting MoCA node for transmissions on said subcarriers to the MoCA node, said determination being based on the detected increase in the current monitored total power value; and
wherein the transceiver is configured to transmit said updated modulation profile to the transmitting MoCA node.

28. The MoCA node of claim 27, further comprising an automatic gain controller (AGC) to perform automatic gain control of the signals seen at the input of the MoCA node; and
the processor is configured to obtain, in response to detecting said increase in the current monitored total power, the gain of the AGC.

29. The MoCA node of claim 28, wherein, if the gain is within a range between a minimum gain value and a maximum gain value, the processor is configured to estimate a change in the signal to noise ratio (SNR) for said subcarriers based on the detected increase in the current monitored total power value and to determine said change of the updated modulation profile based on the estimated change in the SNR.

30. The MoCA node of claim 28, wherein, if the gain is at a minimum gain value, the processor is configured to determine said updated modulation profile on based on the detected increase in the current monitored total power value.

31. The MoCA node of claim 28, wherein, if the gain is at a maximum gain value, the processor is configured to not determine an updated modulation profile.

32. The MoCA node of claim 27, wherein the transceiver comprises a wideband receiver configured to sample the input signals by means of an analog-digital converter (ADC) without down-conversion to baseband or intermediate frequency.

33. The MoCA node of claim 27, wherein the transceiver comprises a narrow-band receiver configured to down-convert the signals to baseband or an intermediate frequency and apply channel filtering on the down-converted signals prior to sampling the channel filtered signals by means of an analog-digital converter (ADC).

34. The MoCA node of claim 27, wherein the updated modulation profile indicates an updated number of bits per modulation symbol for each of the subcarriers.

35. The MoCa node of claim 34, wherein the updated modulation profile indicates a reduction of the bits per modulation symbol for each of the subcarriers.

36. The MoCa node of claim 35, wherein the reduction is uniform for all subcarriers.

37. The MoCA node of claim 27, wherein the transceiver is configured to transmit said determined updated modulation profile in an unsolicited EVM Probe Report LMO message or another unsolicited message.

38. The MoCA node of claim 27, wherein the modulation profile indicates for a unicast link, a normal packet error rate (NPER) bitloading scheme and a very low packet error rate (VLPER) bitloading scheme for the subcarriers.

39. The MoCA node of claim 27, wherein the modulation profile indicates for an OFDMA bitloading profile, a sequence number and updated subchannel definition tables and subchannel assignment tables.

40. The MoCA node of claim 27, wherein the monitoring sub-system is configured to periodically provide the processor with a current total power value or to provide the processor with a current total power value in response to a trigger.

41. The MoCA node of claim 27, wherein the processor is configured to store the current total power value and at least one previous total power value in a memory of the MoCA node.

42. The MoCA node of claim 27, wherein the processor is configured to determine, if the MoCA node is capable of monitoring the signal to noise ratio (SNR) on each of the subcarriers during non-LMO periods; and, if so, to determine the updated modulation profile based on the individual SNR values for the subcarriers.

43. The MoCA node of claim 42, further comprising a SNR monitoring sub-system configured to monitor an SNR on each of the subcarriers, to obtain a respective SNR value for each of the subcarriers.

44. The MoCA node of claim 42, wherein the processor is configured to determine an updated number of bits per modulation symbol for each of the subcarriers based on the respective SNR value for said respective subcarrier, wherein the updated modulation profile indicates the respective updated numbers of bits per modulation symbol for each of the subcarriers.

45. The MoCA node of claim 42, wherein the processor is configured to use the monitored total power values for the update of the modulation profile, if the MoCA node is not capable of monitoring the SNR on each of the subcarriers during non-LMO periods.

46. One or more computer-readable media storing instructions that, when executed by a processor of a MoCA node, cause the MoCA node to adjust the modulation profile for transmission between a MoCA node and a transmitting node, by causing the MoCA node to:
monitor a total power of all signals seen at an input of a transceiver of the MoCA node to obtain a total power value;
detect an increase in a current monitored total power value relative to a previous monitored total power value;
determine an updated modulation profile indicating a bitloading for subcarriers to be used by a transmitting MoCA node for transmissions on said subcarriers to the MoCA node, said determination being based on the detected increase in the current monitored total power value.
